(19) United States
(12) Patent Application Publication
(10) Pub. No.: US 2016/0046327 A1
(43) Pub. Date: Feb. 18, 2016

(54) ANTI-DEFORMATION SPRING BAFFLE

(71) Applicant: Zephyros, Inc., Romeo, MI (US)

(72) Inventors: Dean Quaderer, Livonia, MI (US); Jeffery A. Bradley, Imlay City, MI (US); Erin White, Wales Twp., MI (US); Thomas Bingham, Chesterfield, MI (US)

(21) Appl. No.: 14/828,947

(22) Filed: Aug. 18, 2015

Related U.S. Application Data
(60) Provisional application No. 62/038,563, filed on Aug. 18, 2014.

(51) Int. Cl. B62D 25/00

(52) U.S. Cl. CPC B62D 25/00

(57) ABSTRACT

A device including a steel carrier, an expandable material located about the carrier a fastener connected to one or more of the carrier and expandable material, wherein the steel carrier and expandable material are formed into a loop-shaped profile.

### TECHNICAL FIELD

The present invention relates generally to a baffling, sealing, or reinforcement member that includes a composite structure and one or more fasteners.

### BACKGROUND

The transportation industry continues to require methods of baffling, reinforcement and sealing that provide improved functionality while simultaneously providing reduced weight and cost. Many devices for sealing, baffling and reinforcement require attachment to vehicle panels. When these vehicle panels are made thinner in an attempt to reduce overall vehicle weight, an unintended consequence arises in that the baffling, sealing and reinforcement solutions cause unwanted deformation to panels that are not heavy enough to withstand the solutions. Thus, the continued interest in using light-weight vehicle panels also require improved solutions for sealing, reinforcement and baffling.

### SUMMARY OF THE INVENTION

In a first aspect, the present invention contemplates a method comprising: providing a steel carrier, locating an expandable material about the carrier, forming the steel carrier and expandable material into a loop-shaped profile, locating a fastener connected to one or more of the carrier and expandable material and locating the expandable material into a vehicle cavity adjacent a vehicle panel. The step of locating the expandable material in a loop-shaped profile may include cutting the expandable material to form individual members. The expandable material may be located about the carrier by extrusion. The fastener may be a mechanical fastener that is separately formed from the expandable material. The carrier material may be provided by extrusion and the carrier material is extruded simultaneously with the expandable material. The carrier material may be extruded prior to the extrusion of the expandable material upon the carrier. The carrier material may be coextruded with the expandable material and the resulting coextrusion is further extruded to form the loop-shaped profile configuration. The expandable material may be adapted for forming a sealing material, an acoustical material, an adhesive, a structural foam, or a combination of at least two of the foregoing. The expandable material may be a material that is thermally deformable at the temperature of extrusion but upon thermal activation at an elevated temperature will cross link to form a thermoset material. The expandable material may include a plastic selected from the group consisting of thermoplastics, thermosets, or a combination thereof or a resin selected from the group consisting of an epoxy resin, a thermoplastic resin, an acetate resin, an EPDM resin, a phenoxy resin, a polyurethane resin or a combination thereof. The expandable material loop-shaped profile may include a portion that has a shape selected from an alphanumeric shape, a polygonal shape, a circular shape, an elliptical shape or a combination thereof. At least a portion of the fastener may be embedded in the expandable material. The resulting loop-shaped profile may be sufficiently flexible so that it is capable of flexing and springing upon contact with a vehicle cavity wall and/or vehicle panel. The loop-shaped profile may be sufficiently flexible such that the shape of the profile can be modified to fit within a cavity by pressure placed upon the profile by one or more vehicle cavity walls. The expandable material may have a configuration that is selected from 1) substantially uniform thickness, 2) non-uniform thickness, 3) planar, 4) contoured, 5) geometric, 6) non-geometric, 7) circular cross-section, 8) triangular cross-section 9) rectangular cross-section. The loop-shaped profile may be formed by folding the expandable material upon itself. The fastener may be located through exactly two portions of the expandable material. The fastener may be located through the expandable material after forming of the loop-shaped profile

The invention herein contemplates a device and method for the sealing of cavities with a deformable composite sealing body having one or more fasteners for locating and/or fastening the sealing body within a cavity. The device disclosed herein may allow for effective baffling and/or sealing of a cavity such that the device can be located adjacent to and contact a vehicle panel with minimal or no deformation to the panel.

### DESCRIPTION OF THE DRAWINGS

FIG. 1 shows a perspective view of an illustrative example of the device of the present teachings shown attached to a vehicle panel.

FIG. 2 shows the vehicle panel of FIG. 1 shown from the exterior of the vehicle panel.

FIG. 3 shows the vehicle panel of FIG. 2 whereby the interior of the panel is made visible.

FIG. 4 shows a close-up view of the device of FIG. 1.

FIG. 5 shows the device of FIG. 1 shown from the interior of a vehicle.

### DETAILED DESCRIPTION

The present teachings meet one or more of the above needs by the improved composite structures and methods described herein. The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

This application claims the benefit of the filing date of U.S. Provisional Application Ser. No. 62/038,563, filed Aug. 28, 2014, the entirety of the contents of this application being hereby incorporated by reference for all purposes.

The present invention allows for improved baffling, reinforcement, and sealing of a cavity formed from lightweight vehicle panels.

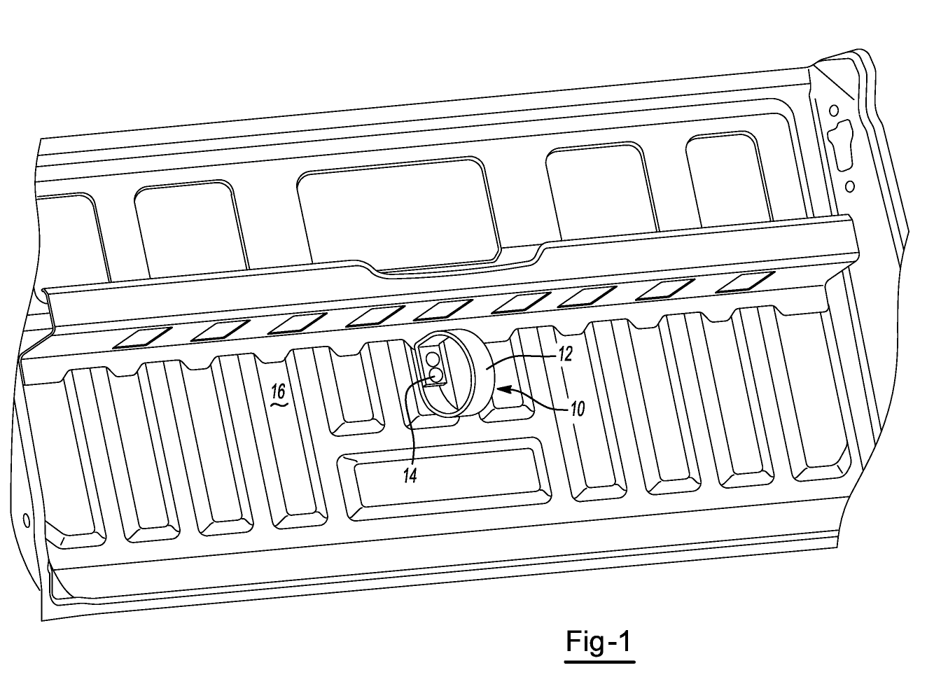

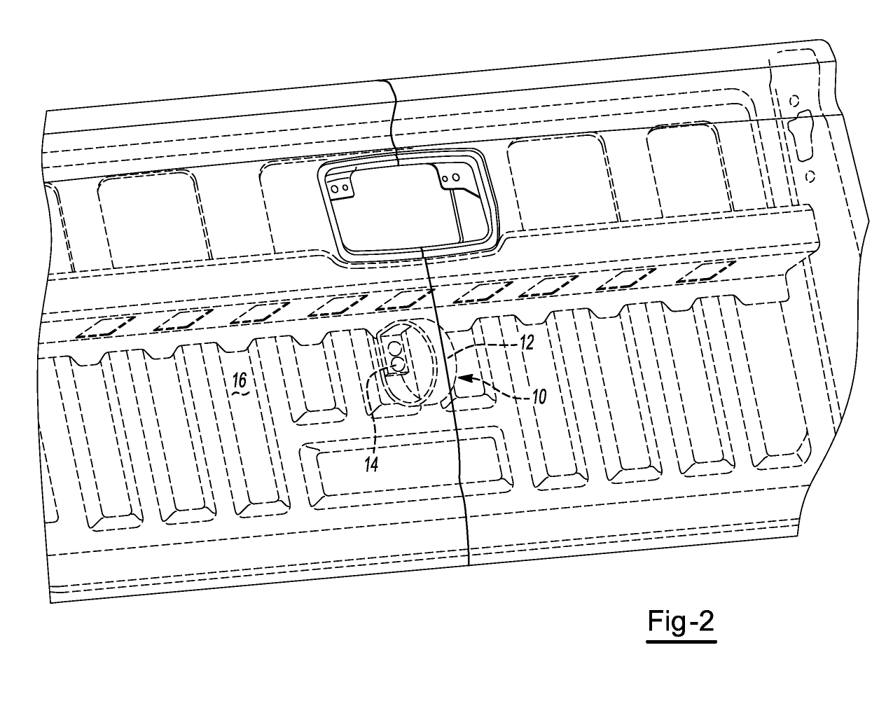

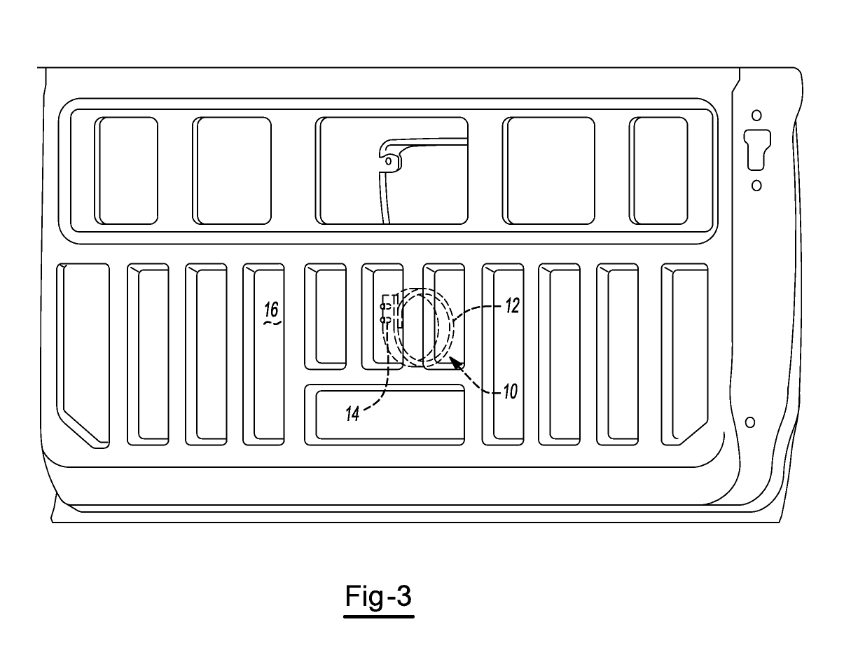

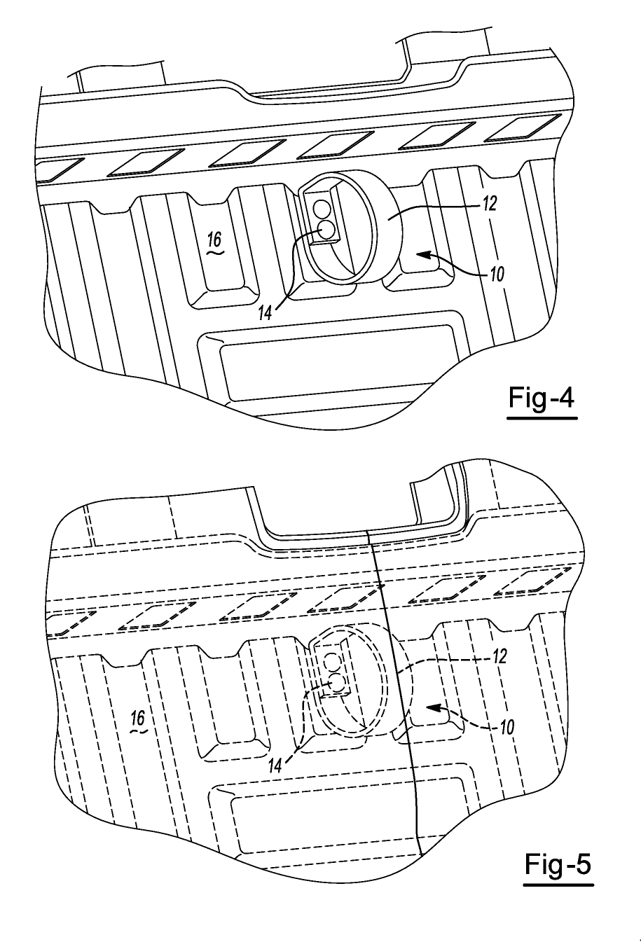

FIGS. 1-5 show the device 10 having an expandable material layer 12 with a carrier material included within (not visible). The device includes a fastener 14. The device is fastened to a vehicle panel 16.

The size of the device may depend upon the size of the cavity in which the device is located. The thickness of the device may be at least about 0.01 mm. The thickness of the device may be less than about 10 mm. The thickness of the device may be from about 0.1 mm to about 6 mm. The thickness of the carrier material layer may be less than the thickness of the expandable material layer. The thickness of the carrier material layer may be greater than the thickness of the expandable material layer. The thickness of the carrier material may be at least about 0.001 mm. The thickness of the carrier material may be less than about 8 mm. The thickness of the carrier material may be from about 0.01 mm to about 5 mm. The thickness of the expandable material layer may be at least about 0.001 mm. The thickness of the expandable material layer may be less than about 8 mm. The thickness of the expandable material layer may be from about 0.01 mm to about 5 mm.

The carrier material may comprise a flat metal sheet. The carrier material may be a high strength to weight metal, such as aluminum, titanium, magnesium or any combination thereof. The carrier material may comprise a steel material (e.g., a carbon steel). The carrier material may also be made of a sheet molding compound or bulk molding compound such as that described in U.S. Pat. No. 7,313,865 incorporated by reference herein for all purposes. The carrier material may also include a mesh material. The carrier material may include a variety of other materials such as polymers, elastomers, fibrous materials (e.g., cloth or woven materials), thermoplastics, plastics, nylon, and combinations thereof. The carrier material of multiple devices may be fabricated from a common sheet of material (e.g., shim steel) to help avoid waste. The carrier material may be flexible to allow for bending of the device to fit within desired small spaces of a cavity.

After placement of the device into a cavity, the expandable material may expand according to a predetermined set of conditions. For example, exposure to certain levels of heat may cause the expandable material to expand. The volumetric expansion of the expandable material may vary depending upon the sealing and/or baffling needs of a particular cavity. The expandable material layer may expand at least about 100%. The expandable material may expand less than about 2000%. The expandable material may expand at least about 500%, at least about 1000%, or more. The expandable material may expand less than about 1000% or even less than about 500%.

The expandable material layer may be generally dry to the touch or tacky and may be shaped in any form of desired pattern, placement, or thickness, but is preferably of substantially uniform thickness. Though other heat-activated materials are possible for the expandable material layer, a preferred heat activated material is an expandable polymer or plastic, and preferably one that is foamable. The expandable material layer may be a relatively high expansion foam having a polymeric formulation that includes one or more of an epoxy resin, an acetate (e.g. ethylene vinyl acetate), a thermoplastic polyether, an acrylate and/or a methacrylate (e.g., a copolymer of butyl acrylate and methyl acrylate), an epoxy/elastomer adduct, and one or more fillers (e.g., a clay filler, and/or a nanoparticle-containing filler). Preferred thermally expandable materials are disclosed in U.S. Pat. Nos. 7,313,865; 7,125,461; and 7,199,165 incorporated by reference herein for all purposes. For example, and without limitation, the foam may also be an EVA/rubber based material, including an ethylene copolymer or terpolymer that may possess an alpha-olefin. As a copolymer or terpolymer, the polymer is composed of two or three different monomers, i.e., small molecules with high chemical reactivity that are capable of linking up with similar molecules. Suitable expandable materials include those available from L&L Products, Inc. under the designations L7220, L2821, L1066, L205, L2010, L2105, L2108A, L2806, L2811, L4200, L4141, L4161, L4315, L5510, L5520, L5540, L5600, L5601, L7102, and L7104. The expandable material layer may be die cut extruded sheets of material. It may be co-extruded with the carrier material.

A number of baffling or sealing foams may also be used for the expandable material layer. A typical foam includes a polymeric base material, such as one or more ethylene-based polymers which, when compounded with appropriate ingredients (typically a blowing and curing agent), will expand and cure in a reliable and predictable manner upon the application of heat or the occurrence of a particular condition. From a chemical standpoint for a thermally-activated material, the foam is usually initially processed as a flowable material before curing, and upon curing, the material will typically cross-link making the material incapable of further flow.

The expandable material can be formed of other materials provided that the material selected is heat-activated or otherwise activated by an ambient condition (e.g. moisture, pressure, time or the like) and cures under appropriate conditions for the selected application. One such material is the epoxy based resin disclosed in U.S. Pat. No. 6,131,897, the teachings of which are incorporated herein by reference. Some other possible materials include, but are not limited to, polyolefin materials, copolymers and terpolymers with at least one monomer type an alpha-olefin, phenol/formaldehyde materials, phenoxy materials, and polyurethane materials with high glass transition temperatures. Additional materials may also be used such as those disclosed in U.S. Pat. Nos. 5,766,719; 5,755,486; 5,575,526; and 5,932,680, incorporated by reference herein for all purposes.

In applications where the expandable material is a heat activated material, an important consideration involved with the selection and formulation of the material is the temperature at which a material cures and, if expandable, the temperature of expansion. Typically, the material becomes reactive (cures, expands or both) at higher processing temperatures, such as those encountered in an automobile assembly plant, when the material is processed along with the automobile structures at elevated temperatures or at higher applied energy levels, e.g., during coating (e.g., e-coat, paint or clearcoat) curing steps. While temperatures encountered in an automobile assembly operation may be in the range of about 148.89° C. to 204.44° C. (about 300° F. to 400° F.) for body shop applications (e.g., e-coat) and, for paint shop applications, are commonly about 93.33° C. (about 200° F.) or slightly higher (e.g., 120° C.-150° C.).

The device may include a fastener such as a tree-fastener or a threaded screw fastener. The fastener may also be provided in a variety of shapes and in a variety of configurations so long as it can secure the device to a cavity. One example of a suitable fastener is disclosed in U.S. Publication No. 2010/0021267 incorporated by reference herein for all purposes. The fastener may be capable of securing multiple layers or types of materials to a structure. Examples of suitable fasteners include mechanical fasteners, clips, tabs, press-fits, snap-fits, screws, hooks, combinations thereof or the like. Furthermore, it is contemplated that the one or more fasteners may be formed integral of a singular material with the material of the device (e.g., the first material or the second material layer) or may be formed of a different material and may be removably attached to the carrier.

The device of the present invention may be installed into an automotive vehicle although it may be employed for other articles of manufacture such as boats, buildings, furniture, storage containers or the like. The device may be used to seal and/or baffle a variety of components of an automotive vehicle including, without limitation, body components (e.g., panels), frame components (e.g., hydroformed tubes), pillar structures (e.g., A, B, C or D-pillars), bumpers, roofs, bulkheads, instrument panels, wheel wells, floor pans, door beams, hem flanges, vehicle beltline applications, doors, door sills, rockers, decklids, hoods or the like of the automotive vehicle.

Formation of the materials of the present invention may include a variety of processing steps depending on the desired configuration of the materials. The device may be formed by an extrusion process followed by optional attachment of fasteners. Additional processing and formation steps may not be required. The formation and processing may thus be free of any molding process. This simplified formation process allows for the shape and size of the device to be quickly modified without requiring a new mold or re-design of the part itself. It is generally contemplated one or more layers of materials or one or more different types of materials, including any fasteners and adhesives may be manually attached to each other, automatically attached to each other or a combination thereof. Moreover, various processes such as molding (e.g., compression, injection or other molding), extrusion or the like may be used to form a carrier material and an expandable material individually and such processes may be employed to attach these materials together.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of the Invention of a range in terms of at “‘x’ parts by weight of the resulting polymeric blend composition” also contemplates a teaching of ranges of same recited amount of “x” in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of” the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1. A method comprising:
providing a steel carrier;
locating an expandable material about the carrier;
forming the steel carrier and expandable material into a loop-shaped profile;
locating a fastener connected to one or more of the carrier and expandable material;
locating the expandable material into a vehicle cavity adjacent a vehicle panel.

2. A method as in claim 1, wherein the step of locating the expandable material in a loop-shaped profile includes cutting the expandable material to form individual members.

3. A method as in claim 1, wherein expandable material is located about the carrier by extrusion.

4. A method as in claim 2, wherein the fastener is a mechanical fastener that is separately formed from the expandable material.

5. A method as in claim 1, wherein the carrier material is provided by extrusion and the carrier material is extruded simultaneously with the expandable material.

6. A method as in claim 2, wherein the carrier material is extruded prior to the extrusion of the expandable material upon the carrier.

7. A method as in claim 1, wherein the carrier material is coextruded with the expandable material and the resulting coextrusion is further extruded to form the loop-shaped profile configuration.

8. The method as in claim 5, wherein the expandable material is adapted for forming a sealing material, an acoustical material, an adhesive, a structural foam, or a combination of at least two of the foregoing.

10. The method as in claim 1, wherein the expandable material is a material that is thermally deformable at the temperature of extrusion but upon thermal activation at an elevated temperature will cross link to form a thermoset material.

11. The method as in claim 8, wherein the expandable material includes a plastic selected from the group consisting of thermoplastics, thermosets, or a combination thereof or a resin selected from the group consisting of an epoxy resin, a thermoplastic resin, an acetate resin, an EPDM resin, a phenoxy resin, a polyurethane resin or a combination thereof.

12. The method as in claim 1, wherein the expandable material loop-shaped profile includes a portion that has a shape selected from an alphanumeric shape, a polygonal shape, a circular shape, an elliptical shape or a combination thereof.

13. The method as in claim 12, wherein at least a portion of the fastener is embedded in the expandable material.

14. The method as in claim 1, wherein the resulting loop-shaped profile is sufficiently flexible so that it is capable of flexing and springing upon contact with a vehicle cavity wall and/or vehicle panel.

15. The method as in claim 14, wherein the loop-shaped profile is sufficiently flexible such that the shape of the profile can be modified to fit within a cavity by pressure placed upon the profile by one or more vehicle cavity walls.

16. The method as in claim 1, wherein the expandable material has a configuration that is selected from 1) substantially uniform thickness, 2) non-uniform thickness, 3) planar, 4) contoured, 5) geometric, 6) non-geometric, 7) circular cross-section, 8) triangular cross-section 9) rectangular cross-section.

17. The method as in claim 12, wherein the loop-shaped profile is formed by folding the expandable material upon itself.

18. The method as in claim 1, wherein the fastener is located through exactly two portions of the expandable material.

19. The method as in claim 1, wherein the fastener is located through the expandable material after forming of the loop-shaped profile.

20. A device comprising:
a steel carrier;
an expandable material located about the carrier;
a fastener connected to one or more of the carrier and expandable material;
wherein the steel carrier and expandable material are formed into a loop-shaped profile.
